(19) United States
(12) Patent Application Publication
(10) Pub. No.: US 2022/0347697 A1
(43) Pub. Date: Nov. 3, 2022

(54) SYSTEM FOR THE PURIFICATION OF THE PARTICULATE PRESENT IN FUMES AND IN EXHAUST GASES IN COMBUSTION PROCESSES

(71) Applicant: DAITECH SA, Chiasso (CH)

(72) Inventor: Salvatore VANELLA, Monteciccardo (IT)

(21) Appl. No.: 17/621,460

(22) PCT Filed: Jul. 2, 2020
(86) PCT No.: PCT/IB2020/056240

§ 371 Date: Dec. 21, 2021

(30) Foreign Application Priority Data
Jul. 5, 2019 (EP) 19184760.7

(51) Int. Cl. B03C 3/41; B03C 3/47; B03C 3/08; B03C 3/12

(52) U.S. Cl. CPC B03C 3/41; B03C 3/47; B03C 3/08; B03C 3/12; B03C 2201/10

(57) ABSTRACT

A system for the purification of the particulate present in fumes and in exhaust gases in combustion processes comprises an Ionizing Part (PI) and a Collection Pan (PR). The Ionizing Part (PI) comprises a perforated portion (40, 50) with at least one electron emitter in the holes (42, 52), consisting of one or more tips (P) to which a negative voltage is applied to create an electron cloud. The negative power supply is provided by a constant voltage generator. The fumes and exhaust gases arc passed through the Ionizing Part (PI) to transfer a negative charge to the particles of the particulate present in the flow of fumes and exhaust gases. The Collection Part (PR) comprises a plurality of positively loaded facing and spaced plates (22b) interposed with a plurality of shield plates (20b) to which no voltage is applied and are not connected to ground, to collect the particles of particulate previously negatively charged.

### FIELD OF THE INVENTION

The present invention relates to a system for the purification of the particulate present in fumes and in exhaust gases in high-density combustion processes. In particular, the system according to the invention aims to improve the efficiency of the reduction especially as regards the fumes and the exhaust gases in combustion processes. The solution proposed herein is mainly dedicated to the filtration of exhaust gases or fumes in combustion processes with high fume temperatures.

### PRIOR ART

Many solutions are known in the art for the purification of the particulate present in the fumes and in the exhaust gases. However, the known solutions do not allow obtaining good results in cases where a high density of particulates is present.

In the known solutions which exploit two plates charged one with positive voltage and one with negative voltage, the particulate reduction efficiency is limited by the value of the applicable electric field. This value is limited by the maximum applicable value without reaching the electric discharge between the two plates. This is because when there is discharge there is the production of ozone, a highly negative condition to be avoided.

Therefore the need is felt to find and propose solutions capable of overcoming and solving the problems of the currently available solutions and of overcoming the drawbacks present in the current solutions.

### SUMMARY OF THE INVENTION

The present invention relates to solutions aimed to improve the efficiency of the reduction, in particular as regards the fumes and the exhaust gases in combustion processes.

A system is therefore provided in the present patent application which includes embodiments which solve the aforementioned and other limits of the known prior solutions.

A system is described for the purification of the particulate present in fumes and in exhaust gases in combustion processes, comprising an Ionizing Part and a Collection Part. The Ionizing Part (PI) comprises a perforated portion with at least one electron emitter in the holes, consisting of one or more tips to which a high negative voltage is applied to create an electron cloud. The negative power supply is provided by a constant voltage generator. The fumes and exhaust gases are passed through the Ionizing Part to transfer a negative charge to the particles of the particulate present in the flow of fumes and exhaust gases. The Collection Part comprises a plurality of positively loaded facing and spaced plates interposed with a plurality of shield plates to which no voltage is applied and are not connected to ground, to collect the particles of particulate previously negatively charged.

In particular, in the illustrated embodiment the Collection Part provides two rack elements which interpenetrate each other.

More in detail, the first rack element comprises a lateral support portion and a plurality of shield plates extending from the lateral support portion, and wherein the second rack element comprises a lateral support portion and a plurality of plates which extend from the lateral support portion, wherein each shield plate of the first rack element is interposed between two plates of the second rack element.

Preferably, a high positive voltage is applied to the second rack element and to the first rack element with the shield plates no tension is applied and the shield plates are not grounded.

The positively charged plates and the intermediate plates not connected to any voltage or even to ground may also be fixed to common lateral support plates where the collection plates are fed by a positive voltage.

In various embodiments, the perforated portion of the Ionizing Part is made from a perforated plate, where at least one electron emitter formed is present in each hole formed by one or more tips to which a negative voltage is applied for the emission of electrons.

In some embodiments, the holes are circular and have a diametrical rib which carries the at least one electron emitter formed by one or more tips.

In alternative embodiments, the circular holes have two diametrical ribs orthogonal to each other which each carry at least one electron emitter formed by one or more tips.

In various embodiments, each rib carries at least one electron emitter formed by a tuft of tips composed of a plurality of filaments with different lengths whose free ends define the tips, and wherein the tuft extends from both sides with respect to the rib, so that the tips are present both upstream and downstream of the hole of the plate.

In alternative embodiments, each rib carries at least one electron emitter formed by a bundle of tips composed of a plurality of filaments with equal length whose free ends define the tips and wherein the filaments extend on both sides with respect to the rib, so that the tips are present both upstream and downstream of the hole of the plate.

In alternative embodiments, the perforated portion of the Ionizing Part is made from a grid with square or rectangular holes where at least one electron emitter formed is present in each hole formed by one or more tips to which a negative voltage is applied for the emission of electrons.

In some embodiments, the at least one electron emitter is arranged on the intersections of the branches which make the grid and/or along the sides of the square holes.

In various embodiments, each branch or each intersection of the branches of the grid carries at least one electron emitter formed by a tuft of tips composed of a plurality of filaments with different lengths whose free ends define the tips, so that the tips are present both upstream and downstream of the holes surrounding the grid.

In alternative embodiments, each branch or each intersection of the branches of the grid carries at least one electron emitter formed by a bundle of tips composed of a plurality of filaments with equal length whose free ends define the tips, so that the tips are present both upstream and downstream of the holes surrounding the grid.

The constant voltage generator has any input voltage and a voltage of between 4 KV and 30 KV is applied to the output terminals.

Alternatively, a negative voltage coming from a second constant voltage generator is applied to the perforated portion of the Ionizing Part.

### BRIEF DESCRIPTION OF THE FIGURES

Further features and advantages of the invention will become apparent upon reading the following description provided by way of non-limiting example with the aid of the figures shown in the accompanying drawings, in which:

FIG. 1 shows an example of embodiment of the system according to the invention,

FIGS. 2A, 2B, 2C, and 2D show some examples of embodiments of the ionizing part of the system with a perforated plate,

FIGS. 3A, 3B, 3C, and 3D show some examples of embodiment of the Ionizing Part of the system with a grid or grating,

FIG. 4 and FIG. 5 are examples of embodiments of the system according to the invention.

The parts according to the present description are represented in the drawings, where appropriate, with conventional symbols, showing only those specific details which are relevant to the understanding of the embodiments of the present invention, so as not to highlight details which will be immediately apparent, to the man skilled in the art, with reference to the description given herein.

### DETAILED DESCRIPTION OF THE INVENTION

The present invention may be applied in all those cases in which the particulate density is high.

The solution described herein is mainly dedicated to the filtration of fumes and exhaust gases in combustion processes.

Of course, the system may also be adopted in the civil field, in any room that requires air purification.

The solution described herein exhibits features of considerable innovation with respect to the previous solutions proposed to date.

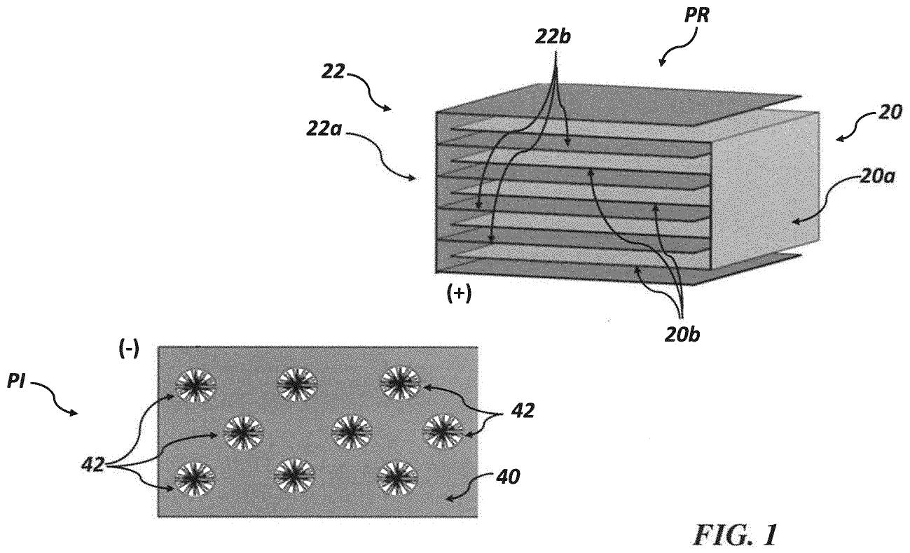

The purification system described herein is composed of two parts, as shown in FIG. 1.

The first part, called Ionizing Part PI, creates an electron cloud starting from a negative power supply supplied by a power supply.

The Ionizing Part PI is crossed by the fumes or by the exhaust gases that contain the particulates and which must be purified.

The Ionizing Part PI has the task of transferring a negative charge to the particles of particulate present in the flow of fumes and exhaust gases passing therethrough. In particular, the particulate polluting particles are negatively ionized by the cloud of electrons that they cross. Therefore, during the passage of the flow of fumes and exhaust gases, the electrons emitted by the Ionizing Part PI are coupled to the particulate polluting particles, and they negatively ionize them.

The second part that forms the purification system, called Collection Part PR, is crossed by the flow of fumes and exhaust gases with “negatively charged” particulate particles and is dedicated to the collection of particulate particles.

In particular, the Collection Part PR has the purpose of collecting and trapping ionized particulate particles, with the aim of purifying the air from the particulates.

The Collection Part PR is fed with a positive polarity and the particulate previously negatively charged in the Ionizing Part PI is deposited thereon.

Therefore, the filtering system is made up of an Ionizing Part PI and a Collection Part PR.

The Ionizing Part PI is composed of electron emission sources, which may have different shapes. In particular, the electron emission sources transfer a negative charge to the particles of particulate present in the fumes passing therethrough.

The Collection Part PR instead has a structure that is crossed by the fumes containing the particles of particulate that have been negatively charged passing through the Ionizing Part PI.

The positive voltage applied to the Collection Part is generated by the same power supply that supplies the Ionizing Part PI and determines an electric field, such as to attract the negatively ionized particulate on the Collection Part PR.

More specifically, the first part, or Ionizing Part PI, is composed of a perforated plate, or a perforated grid. At the center of the holes there is an electron emitter composed of one or more tips P to which a negative voltage is applied.

The support portion which holds the tip or tips P that emit electrons may be made of different materials and shapes, such as a wire mesh with square holes or other shapes where the tip or tips are applied to the corners of the squares or crosses of the branches.

The second part, or Collection Part PR, is formed by a structure composed of a series of parallel plates, placed at a suitable distance to which a positive voltage generated by a power supply is applied.

In particular, the structure of the Collection Part PR provides a plurality of facing and spaced plates. The flow of fume or exhaust gas coming from the Ionizing Part PI, with the negatively charged particulate particles, is made to pass through the passage pipes, or through the inner portions enclosed between the facing plates.

In particular, in the embodiment illustrated in the Figures, the Collection Part PR provides two rack elements 20 and 22 which interpenetrate each other. In particular, the first rack element 20 comprises a lateral support portion 20a and a plurality of plates 20b which extend from the lateral support portion 20a. The second rack element 22 also comprises a lateral support portion 22a and a plurality of plates 22b which extend from the lateral support portion 22a.

The second rack element 22 is connected to the positive voltage generated by the power supply.

In particular, the Collection Part PR therefore comprises a part 22 with the plates positively charged, and a part 20 with shield plates connected or not connected to each other, to which no voltage is applied and which are not connected to ground.

Of course, the materials that make up the parts of this filtering system must be suitable to withstand the fumes and exhaust gases passing therethrough. In particular, the Ionizing Part PI and the Collection Part PR must withstand the high temperatures that the system reaches when it is crossed by the flow of fumes or exhaust gases.

Moreover, in order to optimize the results it is possible to put multiple filtering systems like the one just described in parallel to treat a high quantity of fume to be purified or in series to obtain higher reduction values of the particulate contained.

In the known solutions, the purification system was made up of two plates charged one with positive voltage and one with negative voltage and the particulate reduction efficiency was limited by the maximum value of the electric field. In particular, the maximum reachable value of the electric field was limited by the maximum applicable value without reaching the electric discharge between the two plates with relative ozone production. This situation is certainly to be avoided.

The solution described herein allows eliminating the negatively charged particles of particulate present in the fumes and in the exhaust gases by using a plurality of plates to which a positive voltage is applied.

The purification system has been devised and optimized in order to achieve high reduction yields.

In an alternative embodiment, the power supply is lifted off the ground (earth). The positive terminal (+) feeds the collection plates 22b while the second terminal (−) is connected to the ground T of the electric system.

A negative voltage is applied to the plate 40 of the Ionizing Part PI coming from a second power supply connected to the same ground T (earth).

The two embodiments allow applying high voltages creating high electric fields that allow reaching high reduction efficiencies.

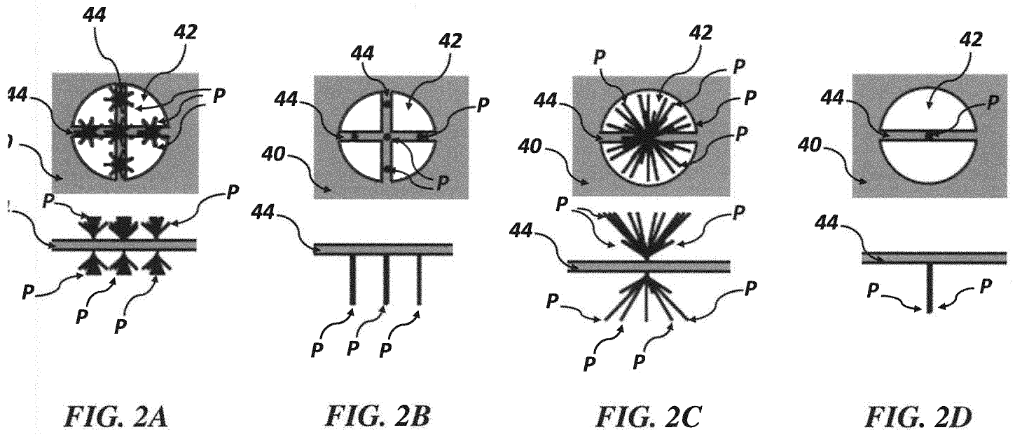

With reference to FIGS. 2A, 2B, 2C and 2D, some possible embodiments of the Ionizing Part PI are now described.

In particular, the Ionizing Part PI may be made from a perforated plate 40, where in each hole 42 there are one or more tips P to which a more or less high negative voltage is applied for the emission of electrons, or a zero voltage. In these embodiments, the holes 42 are circular and different geometries may be provided. More in detail, in FIGS. 2A and 2B the circular hole 42 has two diametrical ribs 44 orthogonal to each other, while in FIGS. 2C and 2D the circular hole 42 has a single diametrical rib 44.

In FIG. 2, the part above is a front view of a hole 42 on the plate 40, while the part below is a lateral section view along the horizontal rib 44.

In FIG. 2A there are three tufts of tips P for each rib 44 arranged in an equidistant manner from each other. In particular, the central tuft is shared between the two ribs. Moreover, the tufts are composed of a plurality of filaments with different lengths the free ends of which define the tips P. In the illustrated embodiment, the tufts extend on both sides with respect to the rib 44, i.e. they are made from filaments with different lengths carried within holes present on the rib 44 and the free ends of which define the tips P. In this way, the tips P are present both upstream and downstream of the hole 42 of the plate 40. It is possible to provide other embodiments in which the tips P are present only upstream or only downstream of the hole 42.

Of course, the terms “upstream” and “downstream” used in the description refer to portions found “before” or “after” in the direction of the flow of fumes or gases.

In the embodiment shown in FIG. 2B there are three bundles of tips P for each rib 44 arranged in an equidistant manner from each other. In particular, the central bundle is shared between the two ribs. The bundles are composed of a plurality of filaments with the same length, the free ends of which define the tips P. In the illustrated embodiment, the bundles are made of filaments with equal lengths extending in one direction starting from holes present on the rib 44 and the free ends of which define the tips P. In this way, the tips P are present only downstream of the hole 42 of the plate 40. It is possible to provide other embodiments in which the tips P are present only upstream of the hole 42, or both upstream and downstream.

In FIG. 2C there is a single tuft of tips P on the single rib 44 present. In particular, the tuft is located at the center of the rib 44 and therefore at the center of the hole 42. The tufts is composed of a plurality of filaments with different lengths the free ends of which define the tips P. In the illustrated embodiment, the tuft extends on both sides with respect to the rib 44, i.e. it is made from filaments with different lengths carried within holes present on the rib 44 and the free ends of which define the tips P. In this way, the tips P are present both upstream and downstream of the hole 42 of the plate 40. It is possible to provide other embodiments in which the tips P are present only upstream or only downstream of the hole 42.

In the embodiment shown in FIG. 2D there is a single bundle of tips P on the rib 44, in particular the bundle is located at the center of the rib 44 and therefore at the center of the hole 42. The bundle is composed of a plurality of filaments with the same length, the free ends of which define the tips P. In the illustrated embodiment, the bundle is made of filaments with equal lengths extending in one direction starting from a central hole present on the rib 44 and the free ends of which define the tips P. In this way, the tips P are present only downstream of the hole 42 of the plate 40. It is possible to provide other embodiments in which the tips P are present only upstream of the hole 42, or both upstream and downstream.

It is possible to provide further embodiments in which several ribs are provided which subdivide the hole 42 or alternatively the tufts or bundles of tips P may be arranged in a different way with respect to the examples illustrated in the Figures, or mixed solutions may be envisaged in which tufts and bundles alternate. Moreover, it is possible to contemplate different geometries for the holes (for example oval).

An alternative embodiment provides a grid 50 in place of the plate 40 and square or rectangular holes 52 in place of the circular holes 42.

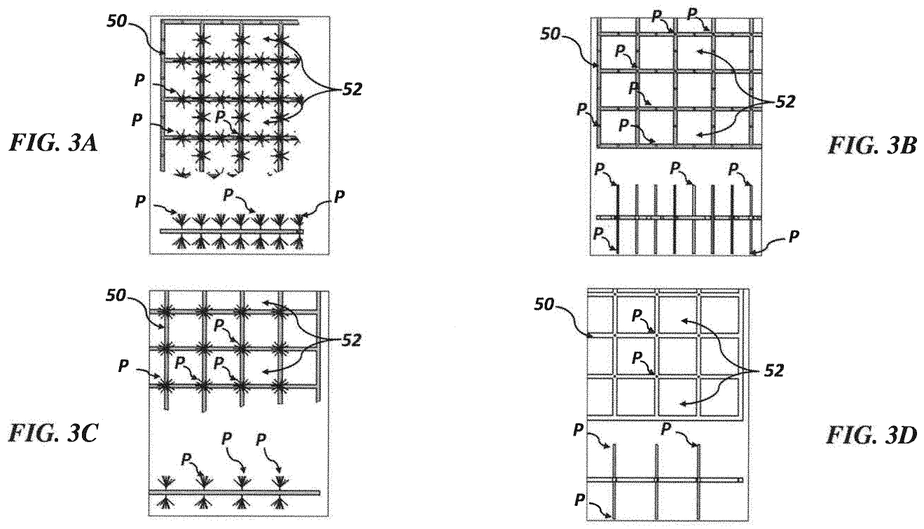

With reference to FIGS. 3A, 3B, 3C and 3D, the Ionizing Part PI may be made with different materials and shapes, such as a wire mesh with square holes or other shapes where the tip or tips P are applied to the intersections of the branches that make up the mesh or grid (FIG. 3C and FIG. 3D) and/or along the sides of the squares and at the intersections of the branches (FIG. 3A and FIG. 3B). In any case, a voltage reference (negative or zero) is applied to the mesh or grid 50 with the precise purpose of generating the emission of electrons from the tips P present therein.

In FIG. 3, the part above is a front view of a mesh portion or grid 50 with the relative square holes 52, while the lower part is a lateral section view along a branch of the grid 50.

In FIG. 3A, a plurality of tufts of tips P is provided for each branch of the grid 50. In particular, for each segment of branch of the grid 50 which defines a square hole 52, or for each side of the hole 52, three tufts are arranged equidistantly from each other. In particular, the tufts arranged on the intersections are shared between two branches orthogonal to each other. The tufts are composed of a plurality of filaments with different lengths the free ends of which define the tips P. In the embodiment shown in FIG. 3A, the tufts extend on both sides with respect to the branch, i.e. they are made from filaments with different lengths carried within holes present on the branch of the grid 50 and the free ends of which define the tips P. In this way, the tips P are present both upstream and downstream of the four holes 52 surrounding the grid 50. It is possible to provide other embodiments in which the tips P are present only upstream or only downstream of the holes 52.

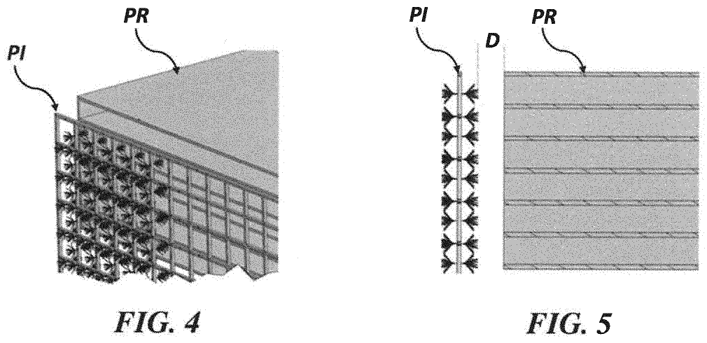

In the embodiment illustrated in FIG. 3B, there is a plurality of bundles of tips P for each branch of the grid 50. The bundles of tips P are arranged equidistantly from each other. In particular, the bundle on the intersection of two branches is shared between the two intersecting orthogonal branches. The bundles are composed of a plurality of filaments with the same length, the free ends of which define the tips P. In the embodiment shown in FIG. 4B, the bundles are made of filaments with equal lengths extending in both directions starting from holes present on the branches and the free ends of which define the tips P. In this way, the tips P are present both upstream and downstream of the four adjacent holes 52 at the intersection of the two branches of the grid 50. It is possible to provide other embodiments in which the tips P are present only upstream or only downstream of the holes 52.

In FIG. 3C there are tufts of tips P arranged at the intersections of two orthogonal branches of the grid 50 which intersect. In particular, each tuft is located at the intersection point between two branches that make up the grid 50. Moreover, each tuft is composed of a plurality of filaments with different lengths the free ends of which define the tips P. In the embodiment illustrated in FIG. 3C, each tuft extends on both sides with respect to the intersection of the branches. Furthermore, each tuft is made of filaments with different lengths carried within holes present at the intersection point of two branches forming the grid 50, and the free ends of which define the tips P. In this way, the tips P are present both upstream and downstream of the four holes 52 of the grid 50 which surround the tuft. It is possible to provide other embodiments in which the tips P are present only upstream or only downstream of the holes 52.

In the embodiment illustrated in FIG. 3D, the bundles are arranged on the intersections of two orthogonal branches of the grid 50 which intersect. In particular, each bundle is located at the intersection point between two branches that make up the grid 50. Each bundle is composed of a plurality of filaments with the same length, the free ends of which define the tips P. In the embodiment shown in FIG. 3d, the bundle is made of filaments with equal lengths extending in both directions starting from a central hole present on the intersection point of two branches forming the grid 50, and the free ends of which define the tips P. In this way, the tips P are present both upstream and downstream of the four adjacent holes 52 of the grid 50. It is possible to provide other embodiments in which the tips P are present only upstream or only downstream of the four holes 52 adjacent to the bundle.

It is possible to provide further embodiments in which the tufts or bundles of tips P are distributed differently with respect to the examples illustrated in FIGS. 3. Moreover, it is possible to contemplate different geometries for the holes 52 (for example rectangular, triangular, circular, oval).

As already mentioned, the materials that make up these filtering systems must be suitable to withstand the fumes and exhaust gases passing therethrough.

Of course, without prejudice to the principle of the invention, the details of construction and the embodiments may widely vary with respect to what has been described and illustrated purely by way of example, without departing from the scope of the present invention.

1. A system for the purification of the particulate present in fumes and in exhaust gases in combustion processes, comprising an Ionizing Part and a Collection Part, wherein the Ionizing Part comprises a perforated portion with at least one electron emitter inside the holes consisting of one or more tips to which a negative voltage is applied to create an electron cloud, wherein said negative supply is provided by a constant voltage generator, in which the fumes and exhaust gases are passed through the Ionizing Part to transfer a negative charge to the particles of particulate present in the flow of the fumes and exhaust gases, and wherein the Collection Part comprises a plurality of positively loaded facing and spaced plates interposed with a plurality of shield plates to which no voltage is applied and are not connected to ground, to collect the particles of particulate previously negatively charged.

2. The system according to claim 1, wherein said Collection Part provides two rack elements which interpenetrate each other.

3. The system according to claim 1, wherein the Collection Part provides a plurality of positively charged plates and a plurality of intermediate plates not connected to any voltage and not even to ground, wherein the plates are fixed to common lateral support plates where the collection plates are fed by a positive voltage.

4. The system according to claim 2, wherein the first rack element comprises a lateral support portion and a plurality of shield plates extending from the lateral support portion, and wherein the second rack element comprises a lateral support portion and a plurality of plates which extend from the lateral support portion, wherein each shield plate of the first rack element is interposed between two plates of the second rack element.

5. The system according to claim 3, wherein a positive voltage is applied to the second rack element and wherein to the first rack element with the shield plates no tension is applied and the shield plates are not grounded.

6. The system according to claim 1, wherein the perforated portion of the Ionizing Part is made from a perforated plate, where at least one electron emitter formed is present in each hole formed by one or more tips to which a negative voltage is applied for the emission of electrons.

7. The system according to claim 5, wherein the holes are circular and have a diametrical rib which carries said at least one electron emitter formed by one or more tips.

8. The system according to claim 5, wherein the holes are circular and have two diametrical ribs orthogonal to each other which each carry at least one electron emitter formed by one or more tips.

9. The system according to claim 6, wherein each rib carries at least one electron emitter formed by a tuft of tips composed of a plurality of filaments with different lengths whose free ends define the tips, and wherein the tuft extends from both sides with respect to the rib, so that the tips are present both upstream and downstream of the hole of the plate.

10. The system according to claim 6, wherein each rib carries at least one electron emitter formed by a bundle of tips composed of a plurality of filaments with equal length whose free ends define the tips, wherein the filaments extend on both sides with respect to the rib, so that the tips are present both upstream and downstream of the hole of the plate.

11. The system according to claim 1, wherein the perforated portion of the Ionizing Part is made from a grid with square or rectangular holes, where at least one electron emitter formed is present in each hole formed by one or more tips to which a negative voltage is applied for the emission of electrons.

12. The system according to claim 10, wherein said at least one electron emitter is arranged on the intersections of the branches which make the grid and/or along the sides of the square holes.

13. The system according to claim 11, wherein each branch or each intersection of the branches of the grid carries at least one electron emitter formed by a tuft of tips composed of a plurality of filaments with different lengths whose free ends define the tips, so that the tips are present both upstream and downstream of the holes surrounding the grid.

14. The system according to claim 11, wherein each branch or each intersection of the branches of the grid carries at least one electron emitter formed by a bundle of tips composed of a plurality of filaments with equal length whose free ends define the tips, so that the tips are present both upstream and downstream of the holes surrounding the grid.

15. The system according to claim 1, wherein said constant voltage generator has any input voltage, is lifted off the ground and a voltage of up to and over 30 KV is applied to the output terminals.

16. The system according to claim 11, wherein a negative voltage coming from a second constant voltage generator connected to ground is applied to the perforated portion of the Ionizing Part.
